(19) United States
(12) Patent Application Publication
(10) Pub. No.: US 2003/0127525 A1
(43) Pub. Date: Jul. 10, 2003

(54) Smart card web and a method for its manufacture

(75) Inventor: Samuli Stromberg, Tampere (FI)

Correspondence Address: FITCH EVEN TABIN AND FLANNERY, 120 SOUTH LA SALLE STREET, SUITE 1600, CHICAGO, IL, 60603-3406, US

(73) Assignee: Rafsec Oy

(21) Appl. No.: 10/310,699

(22) Filed: Dec. 5, 2002

Related U.S. Application Data
(63) Continuation of application No. PCT/FI01/00521, filed on May 31, 2001.

(30) Foreign Application Priority Data
Jun. 6, 2000 (FI) 20001345

(51) Int. Cl. G06K 19/06

(52) U.S. Cl. 235/492

(57) ABSTRACT

The invention relates to a smart card web comprising a carrier web whose softening temperature is at least 110° C., preferably about 180° C., and a cover web whose softening temperature is not higher than 110° C. The invention also relates to a method for the manufacture of a smart card web. In the method, the smart card web is manufactured as a continuous web comprising a carrier web and a cover web attached to each other.

The present invention relates to a smart card web which is normally used as a raw material for further processing in the manufacture of contactless smart cards. The smart cards are rigid cards to be laminated from sheets, their different layers being attached to each other in a press. The smart card comprises a so-called radio frequency identification (RFID) circuit which is typically used at a distance of some tens of centimetres from a reader antenna. Such a smart card can be used for example as an electrical purse, as a ticket in public service vehicles, or for personal identification.

A majority of smart cards according to prior art are laminated from polyvinyl chloride layers (PVC) of different thicknesses, their adhesion being based on heat-sealability between the layers. Apart from the heat-sealability, PVC has the advantage of being easily subjected to further processing. Another material used is acrylonitrile/butadiene/styrene (ABS) copolymer which is a harder material than PVC and thus more difficult to process.

An integrated circuit on a chip is normally first attached to a module by wire bonding, a solder FC joint or an adhesive joint (ICA, ACA, NCA), or by another technology suitable for the attachment of the bare chip. After the attachment, the chip is protected with an epoxy drop. In the next step, the module is attached to the conductive circuit. The most preferred methods for attaching the module are adhesive joints curable at a low temperature, a wire bond formed by utilizing ultrasound, or mechanical bonding methods, such as crimp connection.

One problem has been that it has not been possible to use bonding methods requiring high temperatures in the attachment of the integrated circuit on the chip, because the commonly used materials on whose surface the circuitry pattern is formed, such as PVC or ABS, do not tolerate temperatures exceeding a maximum of about 110° C. without softening. For this reason, the process temperatures must be limited, and a complex technique and time-consuming methods must be used for attaching the integrated circuit on the chip. The above-mentioned methods also involve extra material consumption. On the other hand, if a material resistant to a high temperature were used, its further processability would be poor, because the heat-sealability would be substantially impaired. In this case, the layers would have to be attached by adhesive lamination, which is a relatively complex method to be used in this connection. Yet another problem is that it has not been possible to use a process in which the material would be treated as a continuous web.

By means of a smart card web according to the invention, it is possible to avoid the above-mentioned problems. A smart card web according to the invention is characterized in that the smart card web comprises a carrier web whose softening temperature is at least 110° C., preferably about 180° C., and a cover web whose softening temperature is not higher than 110° C. The method according to the invention is characterized in that the smart card web is manufactured as a continuous web comprising a carrier web and a cover web.

The smart card web according to the invention comprises a cover web and a carrier web, whose surface is provided with successive and/or parallel circuitry patterns which are each equipped with an integrated circuit on a chip. The carrier web bears well high temperatures which are used in some methods for attaching the integrated circuit on the chip to a conductive circuit. One important attachment method is the flip-chip technology which comprises several techniques. The flip-chip technology can be selected upon using materials according to the invention from a large variety in such a way that the production rate of the process can be maximized at an appropriate level of quality and reliability. Suitable flip-chip methods include anisotropically conductive adhesive or film (ACA or ACF) joint, isotropically conductive adhesive (ICA) joint, non-conductive adhesive (NCA) joint, solder flip-chip (FC) joint, or possibly other metallic joints. In addition to the flip-chip technology, also a wire bond or a joint made by tape automated bonding (TAB) can be used. The more freely selectable bonding technology makes it also possible to design and optimize the lines suitable for a material on a roll, i.e. a continuous web, in such a way that the investment required by the lines is better in alignment with the efficiency of the lines than in prior art. Possible materials for the carrier web include e.g. polyester or biaxially oriented polypropylene. The material of the carrier web can also be another suitable material whose thermal resistance properties are at least equal to those of the above-mentioned materials.

The cover web attached onto the carrier web, in turn, improves the further processability of the smart card web by improving e.g. the heat-sealability of the smart card web. Normally, a cover web is attached to both sides of the carrier web, but it is also possible that a cover web is only attached to that side of the carrier web on which the circuitry pattern is formed and to which the integrated circuit on a chip is attached. The cover web protects the circuitry pattern on the carrier web and the integrated circuit on the chip from the effects of e.g. chemicals and ambient conditions. It is thus possible to abandon the protection of the chip with an epoxy drop. Using an adhesive which can be crosslinked by heat, radiation or electromagnetic waves for attaching the carrier web and the cover web, it is possible to control the mechanical properties of the product and, for example, to level out the point where the chip forms a bulge in the smart card web, by allowing the adhesive, in fluid form, to run off from the chip. Furthermore, the smart card web is suitable as such for further processing steps, wherein no additional process steps are required, in addition to possible sheeting. Possible materials for the cover web include polyvinyl chloride, acrylonitrile/butadiene/styrene copolymer, polycarbonate, or polyolefins. The material of the cover web can also be another suitable material whose heat-sealable properties are at least equal to those of the above-mentioned materials.

The attachment of the integrated circuit on the chip to the carrier web can be performed on the same production line as the attachment of the cover web and the carrier web to each other, or on a separate production line. After the lamination, the smart card web is normally sheeted so that it can be subjected to further processing in sheet form.

Normally, the production of a smart card web comprises the following steps:

a circuitry pattern is formed on the surface of the carrier web to be unwound from a roll,

a chip is attached to the circuitry pattern by a suitable flip-chip technology,

the cover web is attached to the carrier web with an adhesive that can be transfer laminated,

the adhesive that attaches the cover web and the carrier web together is crosslinked,

the smart card web is sheeted,

a rigid smart card blank in sheet form is formed by lamination in a press,

the smart card blank is printed,

the smart card blank is punched into separate smart cards,

the smart card is electrically encoded (not in all cases), and

the cards are packed.

The temperatures which the carrier web must tolerate upon the attachment of the chip vary according to the technology. They are often higher than 110° C. When epoxy-based adhesives are used in an anisotropically conductive adhesive bond or in a non-conductive adhesive bond, the required process temperatures are typically higher than 140° C. This is the case also in an isotropically conductive adhesive bond. When a solder bump joint is used, the highest temperatures used are typically about 220° C. In the bonds, it is also possible to use thermoplastic, polymer based adhesives whose process temperatures range from about 140 to 200° C.

In the following, the invention will be described by means of drawings, in which,

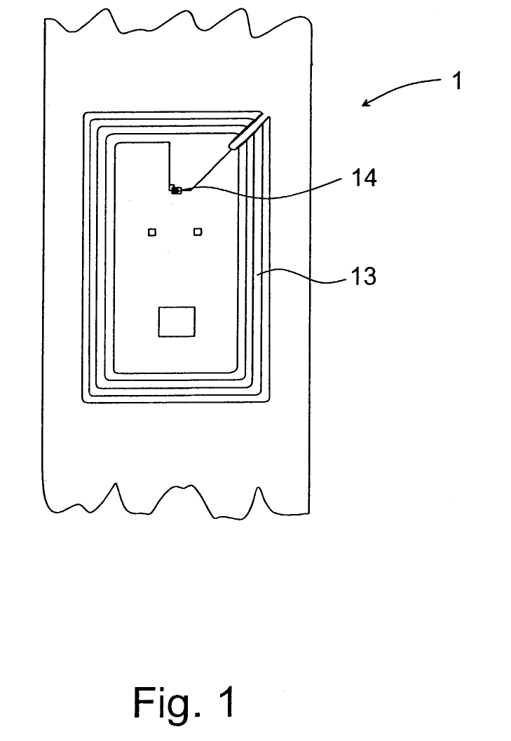

FIG. 1 shows a carrier web in a top view,

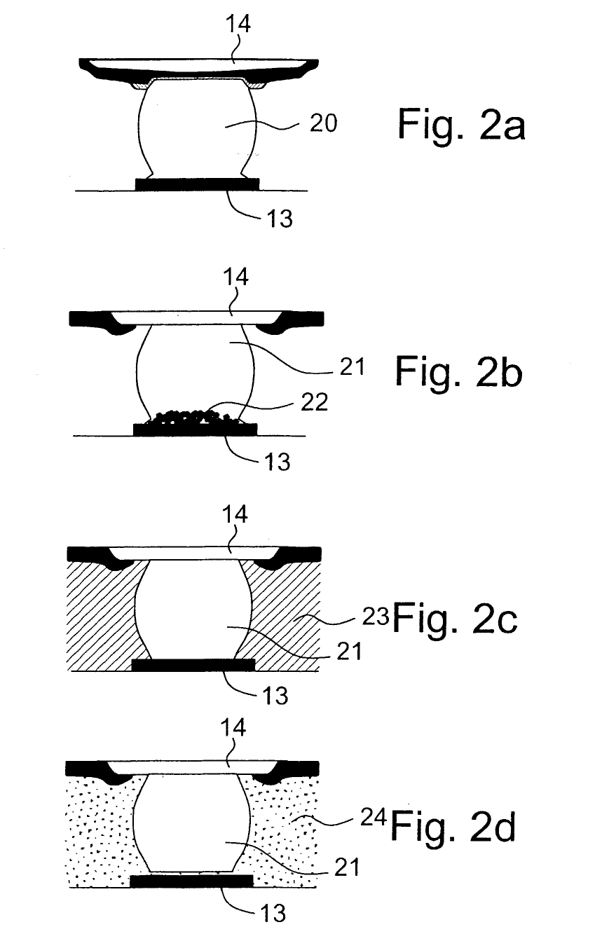

FIG. 2 shows various techniques for attaching an integrated circuit on a chip in a side view, and

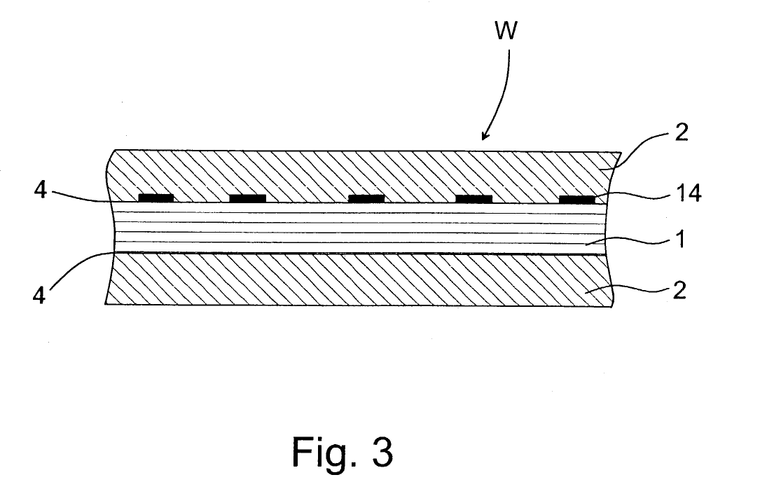

FIG. 3 shows a side view of a smart card web.

FIG. 1 shows a carrier web 1 in a top view. The material of the carrier web 1 is a material resistant to relatively high temperatures, such as polyester. The carrier web 1 contains a single circuitry pattern 13 and an integrated circuit 14 therein. The carrier web 1 contains circuitry patterns 13, each having an integrated circuit 14, at suitable spaces one after another and/or next to each other. The circuitry pattern can be made by printing the circuitry pattern on a film with an electro-conductive printing ink, by etching the circuitry pattern on a metal film, by punching the circuitry pattern off a metal film, or by winding the circuitry pattern of e.g. a copper wire. The circuitry pattern is provided with an identification circuit, such as a radio frequency identification (RFID) circuit. The identification circuit is a simple electric oscillating circuit (RCL circuit) tuned to operate at a defined frequency. The circuit consists of a coil, a capacitor and a circuit integrated on a chip, consisting of an escort memory and an RF part for communication with a reader device. The capacitor of the RCL circuit can also be integrated on the chip.

FIGS. 2a to 2d show possible techniques of attachment to be used for the attachment of an integrated circuit 14 to the circuitry pattern 13 on the carrier web 1. FIG. 2a shows a solder bump 20, by which the integrated circuit on the chip 14 is attached to the circuitry pattern 13. The solder bump 20 is made of a soldering paste.

FIG. 2b shows a joint, in which an isotropically conductive adhesive 22 is attached to the circuitry pattern 13. A solder bump 21, which can be of gold or a mixture of gold and nickel, is attached to the isotropically conductive adhesive. The solder bump 21 is provided with the integrated circuit on the chip 14.

FIG. 2c shows a joint, in which a solder bump 21 is attached between the circuitry pattern 13 and the integrated circuit on the chip 14 and is encapsulated by a non-conductive adhesive 23.

FIG. 2d shows a joint, in which a solder bump 21 is attached between the circuitry pattern 13 and the integrated circuit on the chip 14 and is encapsulated by an anisotropically conductive adhesive 24.

FIG. 3 shows a smart card web comprising a carrier web 1 and a cover web 2 which is attached at interfaces 4 onto both sides of the carrier web 1. The surface of the carrier web 1 is provided with circuitry patterns by printing the circuitry pattern on a film with an electro-conductive printing ink, by etching the circuitry pattern on a metal film, by punching the circuitry pattern off a metal film, or by winding the circuitry pattern of e.g. a copper wire. The circuitry pattern is provided with the integrated circuit on the chip 14. The integrated circuit 14 can be attached to the circuitry pattern by a suitable flip-chip technique, such as anisotropically conductive adhesive or film (ACA or ACF) joint, isotropically conductive adhesive (ICA) joint, non-conductive adhesive (NCA) joint, solder flip-chip (FC) joint, or possibly another metallic joint.

The carrier web 1 is a plastic film that has good thermoresistant properties and a softening temperature higher than 110° C., preferably about 180° C. The material of the carrier web 1 can be for example polyester or biaxially oriented polypropylene which is an advantageous alternative upon using an adhesive curable with ultraviolet radiation.

A cover web 2 is attached at interfaces 4 onto both sides of the carrier web 1, to protect the circuitry pattern on the carrier web 1 and the integrated circuit on the chip 14 from ambient conditions and chemicals. The material for the cover web 2 is a plastic film with suitable properties for further processing, such as polyvinyl chloride, acrylonitrile/butadiene/styrene copolymer, polycarbonate, polyethylene, or polypropylene. Advantageously, the thickness of the cover web 2 is 100 to 200 μm.

The carrier web 1 and the cover web 2 are attached to each other at an interface 4. An adhesive, which can be a pressure-sensitive adhesive (PSA), is transfer laminated onto the interface 4. The adhesive is preferably an adhesive that can be crosslinked by means of heat, radiation or electromagnetic waves, because it can thus be crosslinked further upon the attachment of the carrier web 1 and the cover web 2, or after it, if the aim is to attach the webs firmly to each other. Thus, it is also possible that some adhesive can be removed from the surface of the chip before the crosslinking in such a way that the surface of the smart card web is levelled out. The methods for curing by radiation can be ultraviolet (UV) radiation, microwave radiation, or curing by an electron beam (EB). The adhesive can also be used to replace an underfill that is often needed for attaching an integrated circuit on a chip.

The above description does not restrict the invention, but the invention may vary within the scope of the claims. The materials of the carrier web and the cover web can be different from those presented above. The main idea in the present invention is that when a material which is resistant to high temperatures is used as the carrier web, the attachment of the integrated circuit on a chip to the circuitry pattern on the surface of the carrier web can be made simpler without affecting further processability, because a cover web with good properties for further processing is attached to the surface of the carrier web.

What is claimed is:

1. A smart card web comprising a carrier web including circuitry patterns and integrated circuits on chips, the carrier web having a softening temperature of at least 110° C., and attached to the carrier web is at least on one side of the carrier web a cover web, wherein the cover web has a softening temperature which is not higher than 110° C.

2. The smart card web according to claim 1, wherein it comprises a cover web on each side of the carrier web.

3. The smart card web according to claim 1, wherein the material of the carrier web is polyester, or polypropylene with biaxial orientation.

4. The smart card web according to claim 1, wherein the material of the cover web is polyvinyl chloride, acrylonitrile/butadiene/styrene copolymer, polycarbonate, polyethylene, or polypropylene.

5. The smart card web according to claim 4, wherein an integrated circuit is attached to the carrier web by flip-chip technology.

6. The smart card web according to claim 5, wherein the cover web is heat-sealable.

7. The smart card web according to claim 6, wherein the carrier web and the cover web are attached to each other by means of an adhesive.

8. The smart card web according to claim 7, wherein the adhesive can be subjected to transfer lamination.

9. A method for the manufacture of a smart card web in a continuous manner, the smart card web comprising a cover web and a carrier web including a circuitry pattern and an integrated circuit on a chip, wherein the integrated circuits on the chips are attached to the circuitry patterns formed on the surface of the carrier web in a temperature which exceeds 110° C., and the cover web, which is made of a heat-sealable material is attached to the carrier web.

10. The method according to claim 9, wherein the integrated circuit on the chip is attached to the circuitry pattern by a flip-chip technology.

11. The method according to claim 9 or 10, wherein the integrated circuit on the chip is attached to the circuitry pattern on the same production line on which the carrier web and the cover web are attached to each other.

12. The method according to claim 9 or 10, wherein the integrated circuit on the chip is attached to the circuitry pattern on a production line different from the line on which the carrier web and the cover web are attached to each other.

13. The method according to claim 11, wherein the carrier web and the cover web are attached to each other by means of an adhesive that can be subjected to transfer lamination.

14. The method according to claim 13, wherein the adhesive is crosslinked by means of heat, radiation or eletromagnetic waves after the attachment of the carrier web and the liner web.

15. The method according to claim 14, wherein the adhesive is crosslinked by radiation by using ultraviolet radiation, curing by an electron beam, or microwave radiation.

16. The method according to claim 12, wherein the carrier web and the cover web are attached to each other by means of an adhesive that can be subjected to transfer lamination.

17. The method according to claim 16, wherein the adhesive is crosslinked by means of heat, radiation or eletromagnetic waves after the attachment of the carrier web and the liner web.

18. The method according to claim 17, wherein the adhesive is crosslinked by radiation by using ultraviolet radiation, curing by an electron beam, or microwave radiation.
